(19) United States
(12) Patent Application Publication
(10) Pub. No.: US 2012/0217247 A1
(43) Pub. Date: Aug. 30, 2012

(54) Removable Trash Can Liner System

(76) Inventors: Catherine A. Adkins, Louisville, TN (US); J. Scott Adkins, Louisville, TN (US); Virgil R. Rogers, III, Knoxville, TN (US)

(21) Appl. No.: 13/035,620

(22) Filed: Feb. 25, 2011

(51) Int. Cl. B65F 1/06; B65F 1/14

(52) U.S. Cl. 220/495.08; 220/751

(57) ABSTRACT

A removable trash can liner system for use with a trash can of the type having an interior surface and an upper rim is disclosed. The removable trash can liner system includes a liner defining an at least semi-flexible membrane having an open upper portion defining an upper circumferential edge. The removable trash can liner system further includes a liner holder defining a substantially elongated member adapted to be secured along the trash can upper rim. The liner holder includes a clip configured along the liner holder which is adapted to engage at least a portion of the liner upper portion to releasably secure the liner within the trash can along the trash can interior surface.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to trash can liners. More particularly, this invention pertains to a trash can liner having a mechanism for allowing an upper edge of the trash can liner to be releasably secured proximate an upper rim of a trash can to reduce overhang of the trash can liner over the trash can upper rim.

2. Description of the Related Art

Trash cans of the type defining a vessel having either an open upper rim or a lid defining an opening for receiving and containing trash or other objects (hereinafter “trash”) are known in the art. In common practice, the interior of a trash can is often lined with a flexible liner, such as a paper, cloth, or plastic bag, for easy and sanitary disposal of trash which is thrown therein. In common trash can liner designs, support for the liner along the trash can interior is typically obtained by providing the liner with extra length to enable an upper portion of the liner to be draped over the upper rim of the trash can and to extend downwardly along a portion of an exterior surface of the trash can. Such liner is often then either left loosely draped over the upper rim of the trash can or tied to tighten the liner around the upper rim. One of the problems with this type of liner is that, as trash is received within the trash can and cooperating trash can liner, the trash can liner can slip down from the top of the trash can such that the liner no longer conforms to the upper rim of the trash can, thereby limiting the ability of the trash can liner to receive trash thrown into the trash can. In such instances, the trash can liner must be repositioned in folding relation over the upper rim of the trash can. Another limitation to a traditional trash can liner is waste and expense associated with providing the extra length of liner material to accommodate folding the upper portion of the trash can liner over the upper rim of the trash can.

Also, in certain applications for trash containment and disposal, a trash can is provided having decorative features along an exterior surface thereof. In the case of a trash can having decorative exterior features, a problem arises with a traditional trash can liner in that the upper portion of the trash can liner, when folded down over an upper rim of the trash can and extended a portion of the way down along an exterior surface of the trash can, often covers and obscures the decorative features disposed along the trash can exterior surface. The overhanging upper portion of the trash can liner thus creates an unattractive appearance which detracts from the decorative features of the trash can. In light of the above, a removable trash can liner which is releasably securable proximate the inside of a trash can and which allows the trash can to receive and support the liner with minimal overhang of the liner along the outside of the container, is desired.

### BRIEF SUMMARY OF THE INVENTION

A removable trash can liner system is provided which includes a removable trash can liner and a cooperating liner holder. According to one embodiment of the present invention, the removable trash can liner system includes a trash can liner and a liner holder. The liner holder is defined by a substantially elongated member adapted to generally conform to an upper rim of a trash can such that the liner holder is securable substantially within the trash can along the upper rim of the trash can. Suitable engagement means are provided for securing the liner holder within the trash can along the trash can upper rim. For example, in one embodiment, the liner holder upper edge defines a hooked upper portion sized and configured to engage the trash can upper rim to allow the remainder of the liner holder to hang by the hooked portion from the trash can upper rim along an interior surface of the trash can. The liner holder further defines a clip along the liner holder inner surface which is adapted to engage a circumferential upper portion of the trash can liner to secure the trash can liner upper portion along the liner holder inner surface. In one embodiment, the clip is defined by a pair of linear members extending along the length of the liner holder in a substantially parallel-planar, spaced apart configuration to define a groove therebetween. The groove is adapted to receive at least a portion of the circumferential upper portion of the trash can liner and to engage the received portion of trash can liner to secure the trash can liner upper portion along the liner holder inner surface.

The trash can liner is formed from an at least semi-flexible membrane of the type known in the art and is sized and shaped to allow the trash can liner to generally conform to the interior surface of the trash can. In one embodiment, an upper edge of the trash can liner defines a circumferential tongue adapted to be engaged by the clip to secure the trash can liner upper portion along the liner holder inner surface. In one embodiment, an upper edge of the trash can liner is folded to define a circumferential channel extending along an upper circumference of the trash can liner. A drawstring is received along the circumferential channel such that the circumferential channel and the drawstring cooperate to define the tongue of the trash can liner. An opening is provided in the trash can liner upper portion to give access to the interior of the channel sufficient to allow a user to access the drawstring and to pull at least a portion of the drawstring from within the channel to gather the upper edge of the trash can liner for at least partial closure of the trash can liner. In another embodiment, the liner holder defines a gap in the clip which allows a user to access the tongue and pull the tongue from within the clip to separate the liner from the liner holder. In one embodiment, the opening in the upper edge of the liner is sized to align with the gap in the clip such that a user is able to simultaneously pull the tongue from the clip and pull the drawstring through the channel to at least partially close the upper portion of the trash can liner.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is an exploded perspective view showing one embodiment of a removable trash can liner system in accordance with several features of the present invention;

FIG. 2 is a cross-sectional side view of the removable trash can liner system of FIG. 1;

FIG. 3 is a partial cross-sectional side view showing the cross-section of the liner holder of FIG. 2 in greater detail;

FIG. 4 is a partial cross- sectional side view showing the cross-section of the clip of FIG. 3 in greater detail; and

FIG. 5 is a partial cross-sectional side view showing another embodiment of a removable trash can liner system in accordance with several features of the present invention.

### DETAILED DESCRIPTION OF THE INVENTION

A removable trash can liner system is provided which includes a removable trash can liner and a cooperating liner holder. The liner holder is configured to releasably hold an upper portion of the removable trash can liner proximate an interior upper portion of a trash can. The removable trash can liner system, or system, is referred to at 10 herein and in the accompanying Figures.

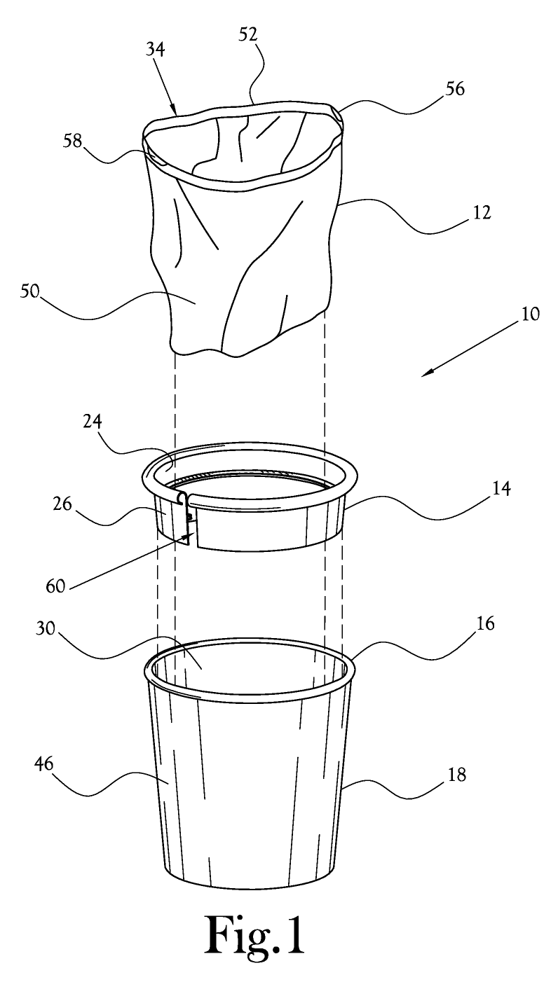

FIG. 1 illustrates an exploded perspective view of one embodiment of a system 10. As shown in FIG. 1, the system 10 includes generally a trash can liner 12 and a liner holder 14. The liner holder 14 is defined by an insert adapted to generally conform to an upper rim 16 of a trash can 18 such that the liner holder 14 is securable substantially within the trash can 18 along the upper rim 16 of the trash can 18. In one embodiment, the liner holder 14 is a substantially linear elongated member having sufficient flexibility to allow a user to bend the liner holder 14 into a shape conforming generally to the trash can upper rim 16 of any of a variety of trash can shapes to allow the liner holder 14 to be secured within the trash can 18 along the trash can upper rim 16. For example, in the illustrated embodiment, the liner holder 14 is bent to a generally circular shape in order to conform generally to the trash can upper rim 16 of a generally cylindrical trash can having a circular upper rim 16. However, it will be understood by one of skill in the art that the liner holder 14 may be bent to conform to a variety of shapes of trash can upper rims 16, for example, triangular, rectangular, polygonal, ovular, and other such shapes, without departing from the spirit and scope of the present invention. In another embodiment, the liner holder 14 defines a shape conforming generally to the trash can upper rim 16 without the need for bending the liner holder 14, such as to allow the liner holder 14 to be received within and mate with the trash can upper rim 16.

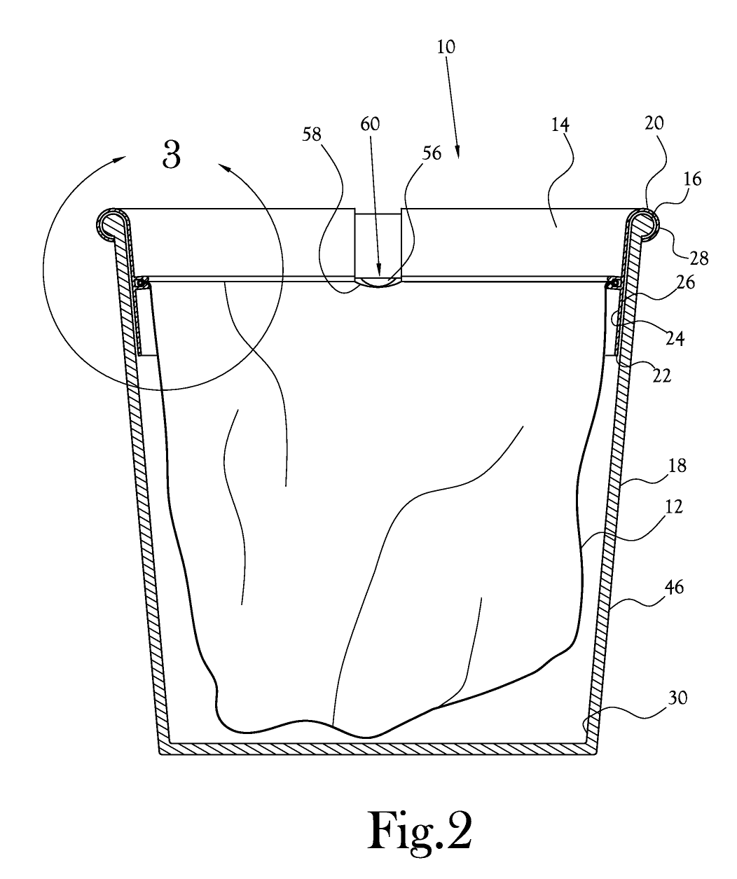

FIG. 2 is a cross-sectional side view of the system 10 of FIG. 1. Referring to FIG. 2, the liner holder 14 defines a substantially planar band having an upper edge 20 and opposite lower edge 22 and defining an inner surface 24 and opposite outer surface 26. Suitable engagement structures are provided along the liner holder upper edge 20 for securing the liner holder 14 within the trash can 18 along the trash can upper rim 16. For example, in the illustrated embodiment, the liner holder upper edge 20 defines a hooked portion 28 extending generally upwardly and outwardly from the liner holder inner surface 24. The hooked portion 28 is sized and configured to engage the trash can upper rim 16 so as to allow the remainder of the liner holder 14 to hang by the hooked portion 28 from the trash can upper rim 16 along an interior surface 30 of the trash can 18 just below the trash can upper rim 16. In another embodiment, a first layer of adhesive material (not shown) is provided between the liner holder outer surface 26 and the trash can interior surface 30 to provide adhesive engagement between the liner holder outer surface 26 and a portion of the trash can interior surface proximate the trash can upper rim 16. Those skilled in the art will recognize other engagement means which may be used to secure the liner holder 14 along the trash can interior surface 30 proximate the trash can upper rim 16, and such engagement means may be used without departing from the spirit and scope of the present invention.

In several embodiments, the hooked portion 28 is sized and configured to limit, and preferably to minimize, visibility of the liner holder 14 along the exterior surface 46 of the trash can 18, thus limiting the ability of the liner holder 14 to detract from the overall appearance of the trash can exterior 46. For example, in one embodiment, the hooked portion 28 is sized to limit, and preferably to minimize, overhang of the liner holder 14 along the exterior surface 46 of the trash can 18. In other embodiments, the liner holder 14 is fabricated from a material having aesthetic properties selected to limit detraction from the overall appearance of the trash can exterior 46. For example, in one embodiment, the liner holder 14 is fabricated from a smooth and at least translucent, and preferably clear, material such that any noticeable appearance of the liner holder 14 along the exterior surface 46 of the trash can 18 is limited. In another embodiment, the liner holder 14 is fabricated from a thermoplastic polymer. In still another embodiment, the liner holder 14 is fabricated from a material selected from the group consisting of low density polyethylene, polypropylene, and flexible polyvinyl chloride. In yet another embodiment, the liner holder 14 is fabricated from a clear polyvinyl chloride material. In other embodiments, the liner holder is fabricated from a material having a color and texture substantially matching that of the trash can 18. Other materials suitable for fabrication of the liner holder 14 will be recognized by one skilled in the art.

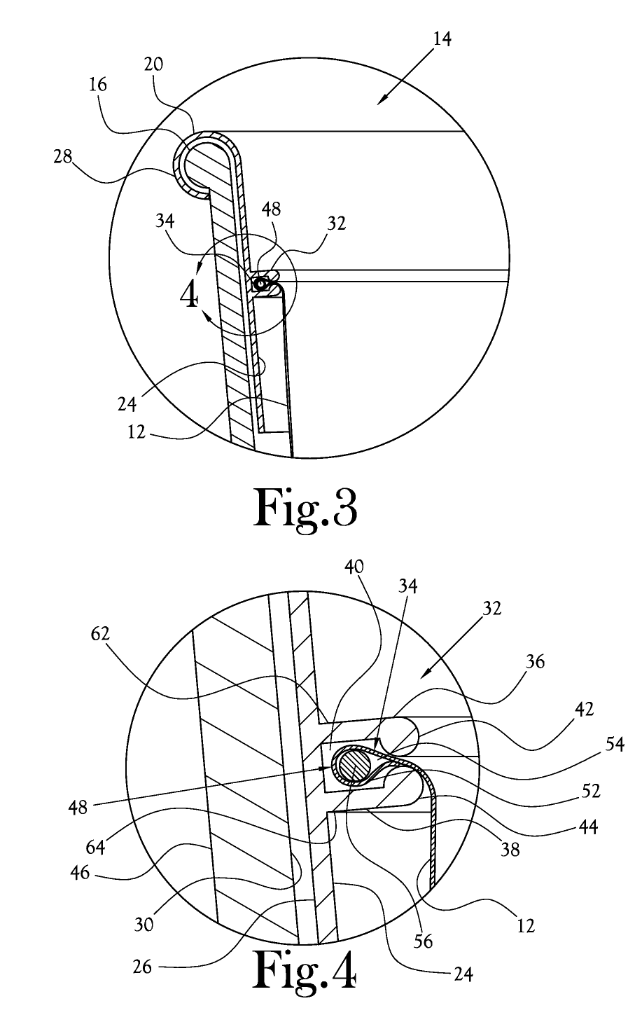

Referring now to FIGS. 3 and 4, a clip 32 is provided along the liner holder inner surface 24. The clip 32 is adapted to engage a perimetrical upper portion 34 of the trash can liner 12 to secure the trash can liner upper portion 34 along the liner holder inner surface 24. In one embodiment, the clip 32 cooperates with the upper portion 34 of the trash can liner 12 to define a frictional connection, such as a tongue and groove connection, tab and socket connection, or the like. For example, in the illustrated embodiment of FIG. 4, the clip 32 is defined by a pair of linear members 36, 38 extending along the length of the liner holder 14 substantially inwardly from the liner holder inner surface 24. The linear members 36, 38 are arranged in a substantially parallel-planar, spaced apart configuration to define a groove 40 therebetween. The groove 40 is adapted to receive at least a portion of the circumferential upper portion 34 of the trash can liner 12 and to engage the received portion of trash can liner 12 to secure the trash can liner upper portion 34 along the liner holder inner surface 24. In one embodiment, the linear members 36, 38 define proximal portions 62, 64 joined to the liner holder inner surface 24 and distal portions 42, 44 defining lips which overhang at least a portion of the groove 40 to at least partially surround and enclose the groove 40 between the linear members 36, 38. The linear members 36, 38 are capable of slight flexure toward and away from one another, and thus, the distal portions 42, 44 of the linear members 36, 38 are capable of slight flexing separation to allow at least a portion of the circumferential upper portion 34 of the trash can liner 12 to be more easily inserted into the groove 40, whereupon the distal portions 42, 44 of the linear members 36, 38 return to their original configuration to at least partially surround and enclose the groove 40 to limit withdrawal of the received portion of trash can liner 12 from within the groove 40 between the distal portions 42, 44. In one embodiment, a second layer of adhesive material (not shown) is provided between the liner holder inner surface 24 and the trash can liner 12 to provide additional engagement between the liner holder inner surface 24 and the trash can liner 12. However, it will be understood that inclusion of the second layer of adhesive material is not necessary to accomplish the present invention.

In the illustrated embodiment, the trash can liner 12 is formed from an at least semi-flexible membrane 50 of the type known in the art and is sized and shaped to allow the trash can liner 12 to generally conform to the interior surface 30 of the trash can 18. In one embodiment, the trash can liner 12 is fabricated from a material selected from the group consisting of low density polyethylene and polypropylene. However, those skilled in the art will recognize other materials suitable for fabrication of the trash can liner 12, and such materials may be used without departing from the spirit and scope of the present invention. In several embodiments, an open circumferential upper portion 34 of the trash can liner 12 defines a circumferential tongue 48 adapted to be received within the groove 40 of the clip 32 and engaged by the clip 32 to secure the trash can liner upper portion 34 along the liner holder inner surface 24. In the illustrated embodiment, an upper circumferential edge 52 of the trash can liner 12 is folded in overlying relation to the remainder of the trash can liner upper portion 34 and secured to the trash can liner upper portion 34 to define a circumferential channel 54 extending along an upper circumference of the trash can liner 12. In this embodiment, a drawstring 56 is slidably received within and along the circumferential channel 54 such that the circumferential channel 54 and the drawstring 56 cooperate to define the tongue 48 of the trash can liner 12.

In the illustrated embodiment, the trash can liner upper portion 34 defines an opening 58 providing access to the interior of the channel 54 sufficient to allow a user to access the drawstring 56 and to pull at least a portion of the drawstring 56 from within the channel 54 through the opening 58, thereby gathering the upper circumferential edge 52 of the trash can liner 12 along a segment of the drawstring 56. In this manner, pulling of the drawstring 56 through the opening 58 allows at least partial closure of the upper portion 34 of the trash can liner 12. In another embodiment, the liner holder 14 defines a gap 60 in the clip 32. For example, in the illustrated embodiment, the linear members 36, 38 of the clip 32 fail to extend along the entire length of the liner holder 14, such that a gap 60 is defined between opposite ends of the linear members 36, 38 of the clip 32. The gap 60 provides a section of the liner holder 14 in which the tongue 48 of the trash can liner upper portion 34 is not substantially surrounded by the clip 32 and allows a user to access and engage the exposed portion of the liner tongue 48 to assist a user in pulling the tongue 48 from within the groove 40 in the clip 32 to separate the liner 12 from the liner holder 14. In the embodiment of FIG. 2, when the liner tongue 48 is inserted within the liner holder clip 32, the alignment of the tongue 48 within the clip 32 is such that the opening 58 in the upper circumferential edge 52 of the liner 12 aligns with the gap 60 in the clip 32. In this embodiment, when the tongue 48 is inserted within the clip 32, and when it is desired to separate the trash can liner 12 from the liner holder 14, a user is able to access and pull the drawstring 56 through the opening 58 at the gap 60, thereby simultaneously pulling the tongue 48 from within the groove 40 of the clip 32 and at least partially closing the upper portion 34 of the trash can liner 12. In certain embodiments, the gap 60 further allows for minor adjustment to the overall shape and circumference of the liner holder 14 to assist in fitting the liner holder 14 in place at the trash can upper rim 16.

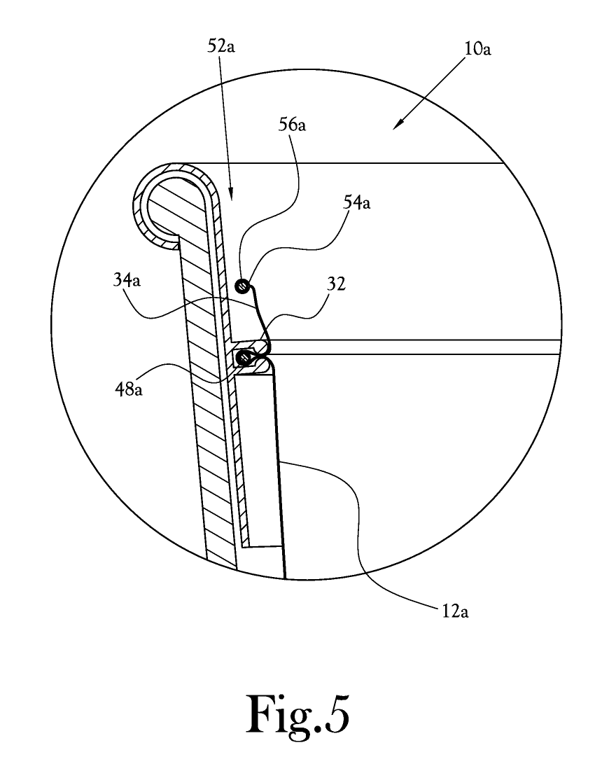

FIG. 5 illustrates another embodiment of the system 10a. In the embodiment of FIG. 5, a separate tongue 48a and drawstring 56a are provided along the upper portion 34a of the trash can liner 12a. More specifically, in the illustrated embodiment, the upper circumferential edge 52a of the trash can liner 12a is folded and secured to the trash can liner upper portion 34a to define a circumferential channel 54a extending along an upper circumference of the trash can liner 12a. The drawstring 56a is slidably received within and along the circumferential channel 54a such that the drawstring 56a runs perimetrically along an upper limit of the liner 12a. A separate tongue 48a is provided slightly offset from and substantially parallel to the channel 54a and cooperating drawstring 56a along the trash can liner upper portion 34a. In the illustrated embodiment, the tongue 48a is defined by a band of substantially flexible material sized and shaped to allow the tongue 48a and a circumferential portion of the trash can liner upper portion 34a to be received within the clip 32 to releasably secure the circumferential portion of the trash can liner upper portion 34a between the tongue 48a and the clip 32. In one embodiment, the tongue 48a is connected along the circumferential portion of the trash can liner upper portion 34a, such as by adhesive or integral connection. In another embodiment, the tongue 48a is separate from the trash can liner upper portion 34a, such that insertion of the tongue 48a and the circumferential portion of the trash can liner upper portion 34a within the clip 32 with the circumferential portion of the trash can liner upper portion 34a wrapped between the tongue 48a and the clip 32 forms a frictional connection to secure the trash can liner upper portion 34a along the liner holder 14.

Those skilled in the art will recognize other possible configurations for the drawstring 56a and tongue 48a. For example, in one embodiment (not shown), the tongue 48a is secured to the liner 12a perimetrically along an upper limit of the liner 12a, and the drawstring 56a and cooperating channel 54a are positioned below the tongue 48a along the liner upper portion 43a. However, such other configurations may be employed without departing from the spirit and scope of the present invention.

From the foregoing description, it will be recognized by those skilled in the art that a removable trash can liner system 10 has been provided which offers a trash can liner which is releasably securable along an interior surface of a conventional trash can, so as to maintain the trash can liner in an open, upright, and expanded position within the trash can absent the need to periodically reposition the trash can liner within the trash can. The removable trash can liner system 10 further offers a device for releasably securing the trash can liner in place within the trash can while reducing, and in certain embodiments minimizing, the appearance of the removable trash can liner system 10 along an exterior surface of the trash can.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A removable trash can liner system for use with a trash can of the type having an interior surface and an upper rim, said removable trash can liner system comprising:
a liner defining an at least semi-flexible membrane, said liner having an open upper portion defining an upper circumferential edge; and
a liner holder defining a substantially elongated member adapted to be secured along the trash can upper rim, said liner holder having a clip configured along said liner holder, said clip being adapted to engage at least a portion of said liner upper portion to releasably secure said liner within the trash can along the trash can interior surface.

2. The removable trash can liner system of claim 1, said liner holder elongated member being formed of a sufficiently flexible material to allow said liner holder to flex into a shape conforming generally to a trash can upper rim.

3. The removable trash can liner system of claim 1, said liner holder defining a hooked portion along a length of said liner holder, said hooked portion adapted to engage the trash can upper rim to allow said liner holder to hang by said hooked portion along the trash can interior surface proximate the trash can upper rim.

4. The removable trash can liner system of claim 3, said hooked portion being fabricated from an at least translucent material.

5. The removable trash can liner system of claim 1, said liner holder defining an outer surface adapted to be secured against the trash can interior surface and an opposite inner surface, said clip including a groove defined along said liner holder inner surface, said groove being adapted to receive and engage at least a portion of said liner upper portion to releasably secure said liner upper portion to said liner holder.

6. The removable trash can liner system of claim 5, said clip further including a pair of linear members extending inwardly from said liner holder inner surface along a length of said liner holder, said linear members being arranged in a substantially parallel-planar, spaced apart configuration to define said groove therebetween.

7. The removable trash can liner system of claim 6, each of said linear members defining a proximal portion joined along said liner holder inner surface and distal portion extending from said liner holder inner surface, said distal portions overhanging a portion of said groove to at least partially surround and enclose said groove between said linear members.

8. The removable trash can liner system of claim 7, said liner upper portion further including a circumferential tongue adapted to be received within said groove to releasably secure said liner upper portion to said liner holder.

9. The removable trash can liner system of claim 8, said tongue being defined by a circumferential channel extending along said liner upper circumferential edge and a drawstring disposed within and along said channel, said drawstring and at least a portion of said channel being sized to be received within said groove to releasably secure said liner to said liner holder.

10. The removable trash can liner system of claim 9, said liner defining an opening in said channel, said opening providing user access to said drawstring sufficient to allow at least a portion of said drawstring to be drawn from within said channel through said opening, thereby effecting at least partial closure of the liner open upper portion.

11. The removable trash can liner system of claim 12, said liner holder defining a gap in said clip, said gap providing access to a portion of said tongue to allow a user to remove said tongue from within said clip.

12. The removable trash can liner system of claim 11, wherein said linear members of said clip terminate along said liner holder length to define said gap between opposite ends of said linear members.

13. The removable trash can liner system of claim 11, said gap in said clip being configured to align with said opening in said channel when said tongue is received within said groove, whereby said gap and said opening cooperate to allow access to said drawstring to allow at least a portion of said drawstring to be drawn from within said channel through said opening to effect at least partial closure of the liner open upper portion and simultaneous separation of said liner from said liner holder.

14. The removable trash can liner system of claim 13, said liner holder elongated member being formed of a sufficiently flexible material to allow said liner holder to flex into a shape conforming generally to a trash can upper rim.

15. The removable trash can liner system of claim 14, said liner holder being fabricated from a material selected from the group consisting of low density polyethylene, polypropylene, and flexible polyvinyl chloride.

16. The removable trash can liner system of claim 14, said liner holder defining a hooked portion along said length of said liner holder, said hooked portion adapted to engage the trash can upper rim to allow said liner holder to hang by said hooked portion along the trash can interior surface proximate the trash can upper rim.

17. An apparatus for securing a liner within a trash can having a rim, said apparatus comprising:
a holder having a band and a hook, said band being selectively insertable into the trash can, said hook facing outward from said band, said hook perimetrically disposed along a top edge of said band, said holder selectively attached to the trash can by fitting said hook over the rim of the trash can;
a channel comprising a pair of substantially parallel walls having a base attached to and extending inwardly from said band at a position below the rim of the trash can;
a retainer secured to the liner, said retainer having a cooperating portion dimensioned to be selectively secured within said channel;
whereby the liner is held in place by inserting said retainer into said channel.

18. The apparatus of claim 17 wherein said retainer and channel cooperate to define a tongue and groove connection.

19. The apparatus of claim 17 wherein said band is non-continuous.

20. The apparatus of claim 17 said retainer including a drawstring slidably secured along an upper circumference of the liner to allow selective closure of the liner upper circumference.
